(19) United States
(12) Patent Application Publication
(10) Pub. No.: US 2025/0353547 A1
(43) Pub. Date: Nov. 20, 2025

(54) Vehicle Having Auto-Steering Guidance System

(71) Applicant: Komatsu America Corp., Chicago, IL (US)

(72) Inventors: Catalin CITEA, Dunlap, IL (US); Nicholas STURM, Bartonville, IL (US); Joel HATTERMANN, Bartonville, IL (US); Douglas SURRATT, Chillicothe, IL (US)

(73) Assignee: Komatsu America Corp, Chicago, IL (US)

(21) Appl. No.: 19/207,482

(22) Filed: May 14, 2025

Related U.S. Application Data
(63) Continuation of application No. 19/206,381, filed on May 13, 2025.
(60) Provisional application No. 63/648,248, filed on May 16, 2024.

(51) Int. Cl. B62D 15/02; B60L 5/24; B60L 5/28; B60Q 9/00; G01S 17/08; G01S 17/931

(52) U.S. Cl. CPC B62D 15/025; B60L 5/24; B60L 5/28; G01S 17/08; G01S 17/931; B60Q 9/00

(57) ABSTRACT

A trolley auto-guided steering is provided to maintain pantographs centered under the power lines, allowing it to achieve higher speeds on grade and reduce wear on a pantograph shoe and/or a carbon brush by moving the contact area within the acceptable constraint limits. The pantograph includes a linkage configured to be mounted to the vehicle and movable relative to the vehicle between a stowed position and a deployed position. A current-collecting rail is supported by the linkage. A sensor assembly is mounted to the pantograph assembly and configured to detect a distance from the overhead wire. Data from the sensor assembly allows for continuous dynamic variable steering toward an aim point determined based on vehicle speed. This helps maintain the work vehicle's position underneath the overhead trolley lines and reduces operator fatigue.

### CROSS-REFERENCE TO RELATED APPLICATIONS

This application is a continuation of U.S. patent application Ser. No. 19/206,381, filed on May 13, 2025, which claims the benefit of U.S. Provisional Application No. 63/648,248, filed on May 16, 2024. The entire disclosures of the above applications are incorporated herein by reference.

### FIELD

The present disclosure relates to a heavy-duty work vehicle, such as a mining truck, and more particularly to a heavy-duty work vehicle having a pantograph associated with a pantograph end adapter, and/or a guiding display to maintain proper alignment between a pantograph and an overhead wire. The present disclosure also relates to a guidance system for the heavy-duty work vehicle.

### BACKGROUND

This section provides background information related to the present disclosure and is not necessarily prior art.

Heavy-duty work vehicles (e.g., off-highway mining or construction vehicles, for example) may be trolley-assist vehicles. Trolley assist vehicles are driven by one or more electric motors that are powered by electrical current supplied through overhead wires (e.g., trolley lines) in addition to a diesel-powered generator or a battery if so equipped. Such vehicles may include a pantograph that can operatively engage the overhead wires to electrically connect the vehicle's power management system associated with motors (or electric-drive distribution system) and/or one or more batteries to be charged. While the vehicle is in motion, it can be challenging for the vehicle operator to maintain proper alignment between the vehicle and the overhead wires. The pantograph must remain in contact with the overhead wires in order to mitigate the occurrence of an arc and electrical flashover, and for the vehicle to continue operation using the one or more electric motors, especially during a trolley-assist mode that bypasses the diesel-powered generator. At such times, the diesel-powered generator may operate at idle.

### SUMMARY

This section provides a general summary of the disclosure and is not a comprehensive disclosure of its full scope or all of its features.

In one form, a pantograph assembly for a vehicle includes a linkage configured to be mounted to the vehicle and movable relative to the vehicle between a stowed position and a deployed position. A current-collecting rail is supported by the linkage. The current-collecting rail includes a first end, a second end opposite the first end, a top surface extending between the first end and the second end, and a bottom surface. The current-collecting rail is configured to slidingly contact an overhead wire when the linkage is in the deployed position, and wherein the current-collecting rail is spaced apart from the overhead wire when the linkage is in the stowed position. An end adapter is attached to one of the first end and the second end of the current-collecting rail, wherein the end adapter is configured to maintain a contact area on or above the current-collecting rail with the overhead wire.

In some configurations, the end adapter includes a top surface, a bottom surface, and a bracket provided on the bottom surface, the bracket securing the end adapter to one of the first end and the second end of the current-collecting rail.

In some configurations, the end adapter includes a generally trapezoidal shape.

In some configurations, the generally trapezoid structure is formed by a first region having a substantially horizontal surface, a second region having a tapered slope inclined upward from the first region, a third region extending from the third region, and a fourth region having a tapered slope inclined downward from the third region.

In some configurations, a first sensor assembly is mounted to the end adapter and configured to detect distance between the overhead wire and a virtual horizontal plane including a sliding contact of the pantograph assembly.

In some configurations, the first sensor assembly is disposed at a position lower than the third region of the end adapter.

In some configurations, the first sensor assembly is further configured to detect presence of the overhead wire.

In some configurations, a second sensor assembly is mounted to the end adapter and configured to detect presence of the overhead wire.

In some configurations, the first sensor assembly is disposed at a position lower than the third region of the end adapter.

In some configurations, the upper surface of the end adapter includes a lip protrusion extending from the fourth region, the lip protrusion including another downwardly tapering slope portion, the upwardly tapering slope, and the lip protrusion limits transverse movement of the overhead wire.

A work vehicle, in accordance with the present disclosure, includes a frame including a cab, a plurality of wheels that are rotatable relative to the frame, an electrical system associated with an electric motor configured to drive one or more of the wheels, and a pantograph assembly mounted to the frame and movable relative to the frame between a stowed position and a deployed position. The pantograph assembly includes a current-collecting rail including a first end, a second end opposite the first end, a top surface extending between the first end and the second end, and a bottom surface. The current-collecting rail is configured to slidingly contact an overhead wire and transmit electrical current from the overhead wire to the electrical system and/or if so provided one or more batteries, when the pantograph assembly is in the deployed position, and the current-collecting rail is electrically disconnected from the overhead wire when the pantograph assembly is in the stowed position. An end adapter is attached to one of the first end and the second end of the current-collecting rail. The end adapter is configured to maintain a contact area on or above the current-collecting rail with the overhead wire.

In some configurations, the end adapter includes a top surface, a bottom surface, and a bracket provided on the bottom surface, the bracket securing the end adapter to one of the first end and the second end of the current-collecting rail.

In some configurations, the end adapter includes a generally trapezoidal shape.

In some configurations, the generally trapezoid structure is formed by a first region having a substantially horizontal surface, a second region having a tapered slope inclined upward from the first region, a third region extending from the third region, and a fourth region having tapered slope inclined downward from the third region.

In some configurations, a first sensor assembly is mounted to the end adapter and configured to detect distance between the overhead wire and a virtual horizontal plane including a sliding contact of the pantograph assembly.

In some configurations, the first sensor assembly is disposed at a position lower than the third region of the end adapter.

In some configurations, the first sensor assembly is further configured to detect presence of the overhead wire.

In some configurations, a second sensor assembly is mounted to the end adapter and configured to detect presence of the overhead wire.

In some configurations, the first sensor assembly is disposed at a position lower than the third region of the end adapter.

In some configurations, the top surface of the end adapter includes a lip protrusion extending from the fourth region, the lip protrusion including another downwardly tapering slope portion, the tapered slope inclined upward, and the lip protrusion limits transverse movement of the overhead wire.

A method of automatically steering a vehicle, in accordance with the present disclosure, includes determining a first distance from a first point to a trolley line, determining a second distance from a second point to the trolley line, determining an aim point based on the first and second distances and a vehicle velocity, determining a turning radius of an arc defined by the aim point, a rear axle center point, and a mirrored aim point, determining a steering angle based on the turning radius and wheelbase length of the vehicle, comparing the steering angle to a current angle of steerable wheels of the vehicle, and determining an amount and direction in which the steerable wheels are to be moved to direct the vehicle toward the aim point.

In some configurations, the vehicle is automatically steered toward the aim point.

In some configurations, automatically steering the vehicle toward the aim point includes maintaining contact between current-collecting rails on the vehicle and the trolley line.

In some configurations, the aim point is continuously updated to maintain the trolley line centered on the current-collecting rails.

In some configurations, determining the first distance includes calculating a trolley line angle of the trolley line relative to a fore-to-aft centerline of the vehicle.

In some configurations, determining the aim point includes setting the aim point at a distance that is equal to vehicle speed multiplied by a forward velocity gain value.

A pantograph assembly, in accordance with the present disclosure, includes a linkage configured to be mounted to the vehicle and is movable relative to the vehicle between a stowed position and a deployed position. A current-collecting rail is supported by the linkage. The current-collecting rail is configured to slidingly contact an overhead wire when the linkage is in the deployed position, and the current-collecting rail is spaced apart from the overhead wire when the linkage is in the stowed position. A sensor assembly is mounted to the current-collecting rail and configured to detect a distance from the overhead wire. The sensor assembly includes a sensor and a support bracket, the support bracket is mounted to the current-collecting rail and supports the sensor.

In some configurations, an end adapter is attached to an end of the current-collecting rail, an uppermost surface of the sensor is disposed vertically below an uppermost surface of the end adapter.

In some configurations, the sensor assembly includes a time-of-flight sensor.

In some configurations, the sensor assembly includes a LIDAR sensor.

In some configurations, the sensor assembly includes a cylindrical lens into which a collimated beam is transmitted, and wherein the cylindrical lens spreads the collimated beam into a fan beam.

In some configurations, as a substitute for the sensor, or in addition to the sensor, a camera is mounted to the end adapter. The camera is configured to detect the positional relationship between the overhead wire and the pantograph assembly. In addition to the positional detection, with an AI (artificial intelligence) assisted recognition, the camera and an image recognition system may be configured to detect wearing of the overhead wires as well as the state of the carbon brush (or a carbon contact strip) attached to the surfaces of the current-collecting rail. Further, in some configurations, the camera with the image recognition system is configured to detect the generation of arcs that can damage the pantograph and overhead wires.

In some configurations, the sensor assembly is in communication with a guidance system.

In some configurations, the guidance system includes a plurality of lights disposed in a cab of the vehicle, and wherein the lights are operable to indicate a position of the vehicle relative to the overhead wire.

In some configurations, the guidance system includes a control module in communication with the sensor assembly and the lights, and wherein the control module controls operation of each of the lights based on data received from the sensor assembly.

A work vehicle, in accordance with the present disclosure, includes a frame including a cab, a plurality of wheels are rotatable relative to the frame. An electrical system associated with an electric motor is configured to drive one or more of the wheels. A pantograph assembly is mounted to the frame and is movable relative to the frame between a stowed position and a deployed position. The pantograph assembly includes a current-collecting rail that is configured to slidingly contact an overhead wire and transmit electrical current from the overhead wire to the electrical system when the pantograph assembly is in the deployed position, and the current-collecting rail is electrically disconnected from the overhead wire when the pantograph assembly is in the stowed position. A sensor assembly is mounted to the pantograph assembly and is configured to detect a distance from the overhead wire. A visual display is disposed within the cab and configured to provide visual indicia of a position of the heavy-duty work vehicle relative to the overhead wire. A control module is in communication with the sensor assembly and the visual display and is configured to control the visual indicia on the visual display based on data received from the sensor assembly. The sensor assembly includes a sensor and a support bracket, the support bracket supports the sensor and is mounted to an end adapter attached to the current-collecting rail.

In some configurations, an uppermost surface of the sensor is disposed vertically below an uppermost surface of the end adapter.

In some configurations, the sensor assembly includes a time-of-flight sensor.

In some configurations, the sensor assembly includes a LIDAR sensor.

In some configurations, the sensor assembly includes a cylindrical lens into which a collimated beam is transmitted, and wherein the cylindrical lens spreads the collimated beam into a fan beam.

In some configurations, the current-collecting rail includes a first current-collecting rail and a second current-collecting rail joined by a connection rail arranged perpendicularly to the first current-collecting rail and the second current-collecting rail, the sensor comprising a camera mounted to the rail.

A work vehicle, in accordance with the present disclosure, includes a frame including a cab. A plurality of wheels are rotatable relative to the frame. An electrical system associated with an electric motor is configured to drive one or more of the wheels. A pantograph assembly is mounted to the frame and is movable relative to the frame between a stowed position and a deployed position. The pantograph assembly includes a current-collecting rail that is configured to slidingly contact an overhead wire and transmit electrical current from the overhead wire to the electrical system and, if so provided, to one or more batteries when the pantograph assembly is in the deployed position, especially during a trolley assist mode where a diesel powered generator is idle and is being bypassed The current-collecting rail is electrically disconnected from the overhead wire when the pantograph assembly is in the stowed position. A sensor assembly is mounted to pantograph assembly and is configured to detect a distance from the overhead wire. A visual display is disposed within the cab and is configured to provide visual indicia of a position of the work vehicle relative to the overhead wire. A control module is in communication with the sensor assembly and the visual display and is configured to control the visual indicia on the visual display based on data received from the sensor assembly.

In some configurations, the visual indicia include a plurality of lights disposed in the cab, wherein the plurality of lights are operable to indicate the position of the pantograph assembly relative to the overhead wire.

In some configurations, the control module controls operation of each of the lights based on data received from the sensor assembly.

In some configurations, the visual display includes a light bar, the plurality of lights being arranged in a linear array across the light bar.

In some configurations, the control module is configured to control a display color of one or more of the plurality of lights based on the position of the pantograph assembly relative to the overhead wire.

In some configurations, the control module is configured to control a display intensity of one or more of the plurality of lights based on the position of the pantograph assembly relative to the overhead wire.

In some configurations, the light bar includes a right end, a left end, and a center, the control module is configured to control activation of select ones of the plurality of lights at one or more of the left end, the right end, and the center of the light bar based on the position of the pantograph assembly relative to the overhead wire.

In some configurations, the control module is configured to illuminate select ones of the plurality of lights to indicate that the current-collecting rail is electrically connected to the overhead wire.

In some configurations, the sensor assembly includes a camera mounted adjacent to the current-collecting rail, the visual indicia being a camera image presented on a screen, the camera image showing a position of the overhead wire relative to the current-collecting rail and an arc generated between the current-collecting rail and the overhead wire.

In some configurations, the control module includes a guidance system and an automatic steering control operable to maintain contact between the current-collecting rail and the overhead wire without operator input.

A method of guiding a work vehicle to maintain connect between a current-collecting rail and an overhead wire, in accordance with the present disclosure, includes determining a first distance from a first point on the current-collecting rail to the overhead wire, determining a second distance from a second point on the current-collecting rail to the overhead wire, and presenting, on a visual display, a visual indicia of the first distance and the second distance.

In some configurations, an aim point is determined based on the first and second distances and a vehicle velocity, and the visual indicia of the aim point is provided on the visual display.

In some configurations, presenting the visual indicia of the first distance and the second distance includes illuminating select ones of a plurality of lights on a light bar.

In some configurations, illuminating select ones of a plurality of lights on the light bar includes controlling an intensity of the select ones of the plurality of lights on the light bar.

In some configurations, illuminating select ones of a plurality of lights on the light bar includes controlling a color of the select ones of the plurality of lights on the light bar.

In some configurations, illuminating select ones of a plurality of lights on the light bar includes controlling a position of the select ones of the plurality of lights on the light bar.

In some configurations, illuminating select ones of a plurality of lights on the light bar includes controlling at least two of an intensity, a color, and a position of the select ones of the plurality of lights on the light bar.

In some configurations, providing the visual indicia of the aim point includes illuminating one or more lights at a center of the light bar and select ones of the plurality of lights to one of a left side and a right side of the center of the light bar.

In some configurations, a visual indicia indicating a connection between the current-collecting rail and the overhead wire is presented.

In some configurations, presenting the visual indicia includes displaying a camera image on a display screen showing the first distance and the second distance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a heavy-duty work vehicle with a pantograph assembly, in accordance with the present disclosure;

FIG. 2 is a perspective view of a pantograph assembly, in accordance with the present disclosure;

FIG. 3 is a perspective view of an end adapter for the pantograph assembly, in accordance with the present disclosure;

FIG. 4 is another perspective view of the end adapter of FIG. 3, in accordance with the present disclosure;

FIG. 5 is another perspective view of the end adapter of FIG. 3, in accordance with the present disclosure;

FIG. 6A is a perspective views of the mounting assembly for the end adapter of FIG. 3, in accordance with the present disclosure;

FIG. 6B is a perspective views of a sensor connected to the mounting assembly of FIG. 6A, in accordance with the present disclosure;

FIGS. 7A-7B are perspective views of an operator cab fitted with a light bar, in accordance with the present disclosure;

FIGS. 8A and 8B are schematic illustrations of the light bar, in accordance with the present disclosure;

FIG. 9 is a perspective view of an end adapter for a pantograph assembly according to another aspect of the present disclosure;

FIG. 10 is a block diagram of a controller, multiple sensors, and a steering actuation system for an auto-steering vehicle guidance system, in accordance with the present disclosure;

FIG. 11 is schematic representation of the vehicle and aim point, in accordance with the present disclosure;

FIG. 12 is a schematic representation of the vehicle turning toward the aim point at a turning radius determined by the controller, in accordance with the present disclosure;

FIG. 13 depicts current collecting rails of the pantograph assembly in contact with overhead wires, in accordance with the present disclosure;

FIG. 14 depicts a lens and a lens housing of a laser distance sensor, in accordance with the present disclosure;

FIG. 15 depicts a collimated laser beam passing through the lens of FIG. 14 onto a target, in accordance with the present disclosure;

FIG. 16 illustrates differences between the collimated laser beam passing through the lens to the target and the collimated laser beam passing directly to the target;

FIG. 17 depicts sensor assemblies mounted to right and left hand side end adapters of the pantograph a system of FIG. 1, in accordance with the present disclosure;

FIG. 18 depicts the collimated laser beam hitting an overhead wire without passing through the lens of FIG. 14;

FIG. 19 depicts the collimated laser beam hitting an overhead wire after passing through the lens of FIG. 14, in accordance with the present disclosure; and

FIG. 20 illustrated a camera mounted to the pantograph assembly of FIG. 1 directed to the overhead wire and an output of the camera sensor in an operator's cab display of the heavy duty vehicle, in accordance with the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure provides an end adapter for a pantograph and a guidance system that assists in maintaining proper alignment between the vehicle and the overhead wires. These features improve operating efficiency and reduce productivity losses.

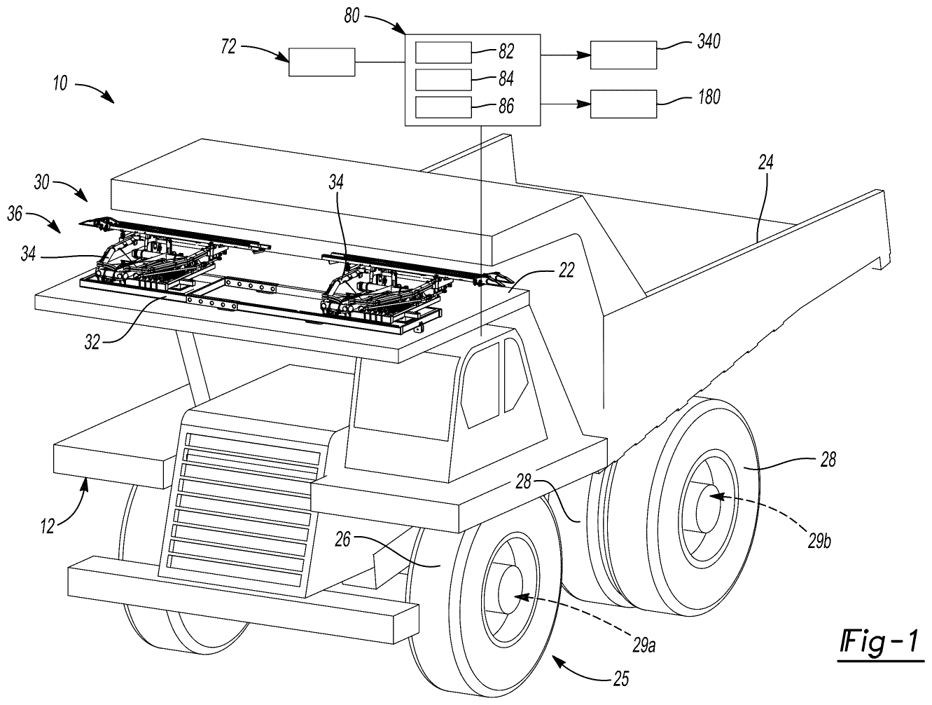

Referring to FIG. 1, a heavy-duty work vehicle 10 is illustrated in accordance with an exemplary embodiment of the present invention. Although the heavy-duty work vehicle 10 is illustrated as a mining truck, the heavy-duty work vehicle 10 can be any type of vehicle in any suitable industry including, but not limited to, construction, forestry, agriculture, waste management and drilling.

The heavy-duty work vehicle 10 includes a main frame 12 that supports an operator's cab 22 from which a driver operates the heavy-duty work vehicle 10, as shown in FIG. 1. A dump body 24 is movably connected to an upper part of the main frame 12 and is configured to carry loads (e.g., mined materials, rock, concrete, sand) away from a worksite. The dump body 24 is moved by extensions and contractions of a cylinder (not shown) and may be rotatable relative to the main frame 12. A plurality of wheels 25 are rotatably connected to the main frame 12. Plurality of wheels 25 include front wheels 26 disposed on each of the front-right and front-left sides of the heavy-duty work vehicle 10 and a pair of rear wheels 28 disposed on each of the rear-right and rear-left sides of the heavy-duty work vehicle 10. Each front wheel 26 may include an electric motor 29a and each rear wheel 28 may include an electric motor 29b. Electric motors 29a and 29b drive some or all of the wheels 26, 28.

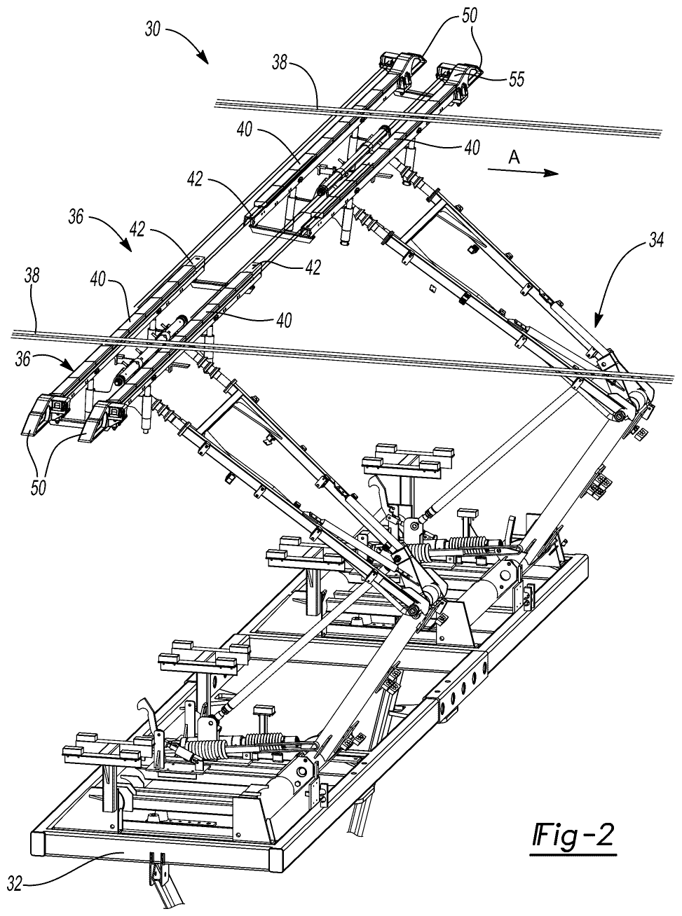

The heavy-duty work vehicle 10 is equipped with a pantograph assembly 30 configured to supply/relay power to the heavy-duty work vehicle 10 (e.g., to power an electrical system that may include the one or more electric motors and/or to charge one or more batteries (not shown) if so equipped) from one or more overhead wires (or trolley lines). The pantograph assembly 30 is movable between a collapsed (or stowed) position (shown in FIG. 1) and an extended (or deployed) position (shown in FIG. 2) in which the pantograph assembly 30 is raised to contact the trolley line. The heavy-duty work vehicle 10 can transition between an on-trolley mode where power is received from an overhead trolley line and an off-trolley mode where power is received from a power source (not shown) on-board heavy-duty work vehicle 10.

Referring to FIG. 2, the pantograph assembly 30 may include a base 32, a linkage assembly 34, and current-collecting rails 36. The current-collecting rails 36 are connected to the base 32 though the linkage assembly 34. The current-collecting rails 36 are arranged perpendicular to overhead trolley lines 38 to define sliding contacts along a virtual horizontal plane that includes “A” in FIG. 2 (herein after virtual horizontal plane “A”). A carbon brush or a carbon contact strip 40 may be disposed on a top surface 42 of the current-collecting rails 36 extending longitudinally along the virtual horizontal plane A. The carbon brush 40 is disposed on each of the current-collection rails 36 for making physical contact with the trolley lines 38 allowing for electric current transfer with minimal friction, wear and tear, and dangerous electrical arcing, and may extend the entire length of the current-collecting rails 36 or may extend a partial length of the current-collecting rails 36.

In addition, the virtual horizontal plane A can be defined as including upper surfaces of the carbon brushes 40. However, the carbon brush 40 generally has flexibility and compressibility and may be expendable so that, for convenience, the thickness of the carbon brushes 40, (generally 5-10 mm) will be disregarded in the following explanation. Further, due to the above reasons, the term “sliding contact” in this application may be considered as both an upper surface of the current-collecting rail 36 and an upper surface of the carbon brush 40.

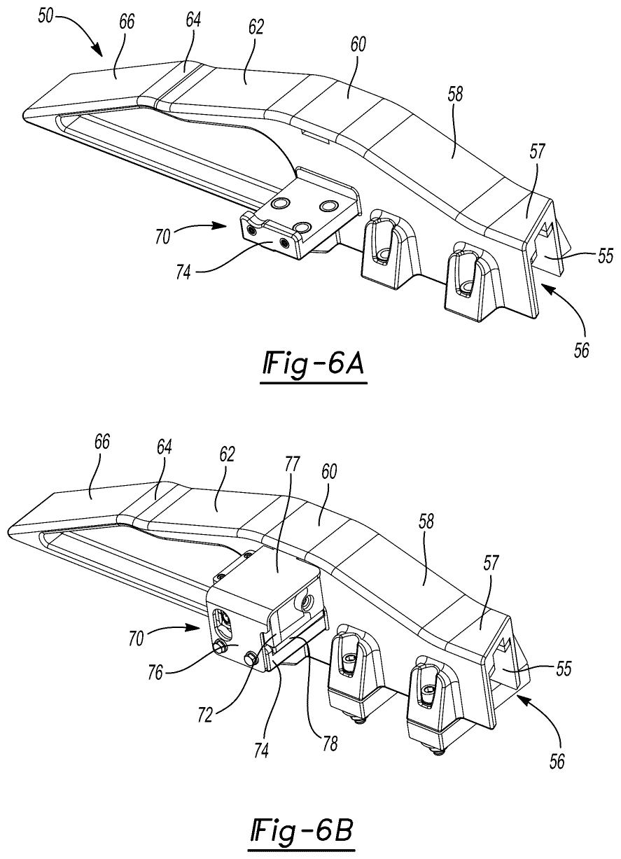

The pantograph assembly 30 includes end adapters 50 connected to an end of the current-collecting rails 36. The carbon brush 40 may extend along the current-collecting rails 36 up to an end 55 of the end adapter 50 (see FIGS. 6A-6B). While only one set of end adapters are shown, the pantograph assembly may additionally include a second set of end adapters 50 connected at the opposite end of the current-collecting rails 36.

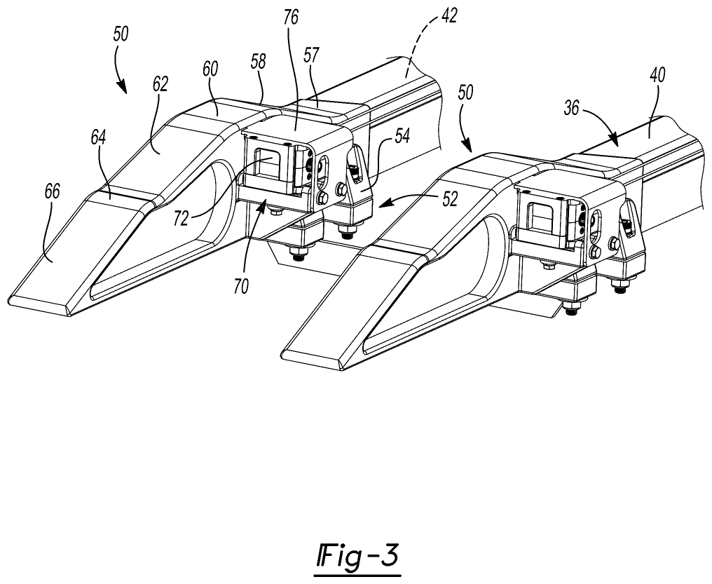

Referring to FIGS. 3, 4, 5, 6A, and 6B the end adapter 50 is formed as a single body configured to be engaged with a top surface 42 of the current-collecting rails 36. The end adapter 50 contains a recessed cavity 56 (FIG. 6A) with a top inner surface (not separately labeled) of the recessed cavity 56 being engaged with the top surface 42 of the current-collecting rails 36. In some embodiments, a spacer 88 (FIG. 5) may be installed on the top surface 42 of the current-collecting rails 36. The spacer 88 extends between an end of the end adapter up to an end of the carbon brush 40 and, in this manner, the spacer 88 ensures a smooth transition between the carbon brush 40 and the end adapter 50.

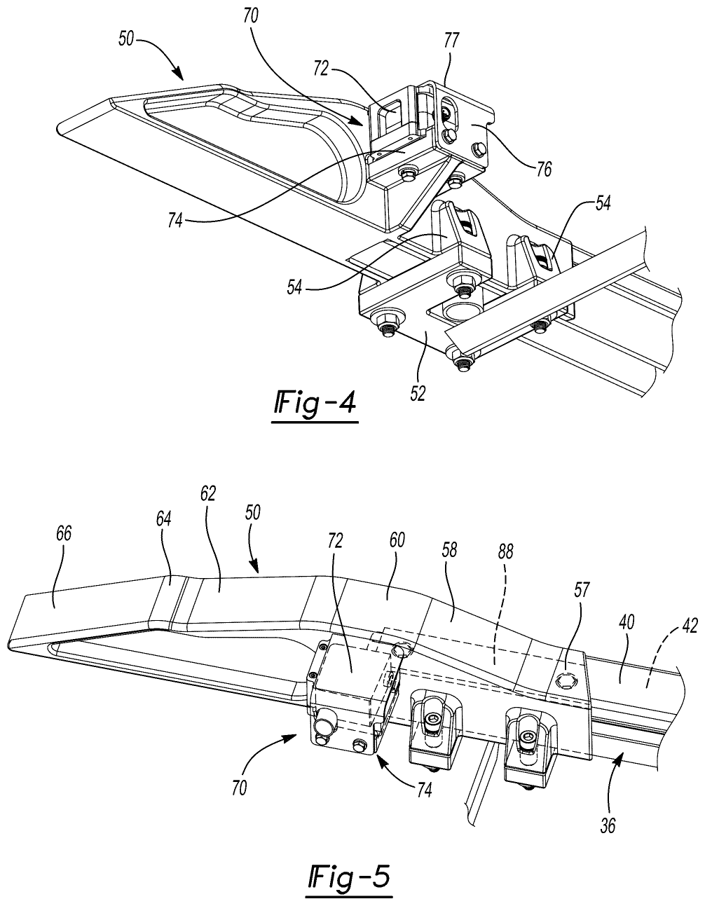

As shown in FIGS. 3 and 4, the end adapter 50 may be fastened to the current-collecting rails 36 through a clamp 52 extending between the sides of the end adapter 50 across a bottom surface (not separately labeled) of the current-collecting rails 36. A plurality of brackets 54 with through holes are installed on each side of the end adapter 50 and is configured to facilitate the coupling between the clamp 52 through any suitable mechanical fastening means such as bolts screws, pins, and the like. The clamp 52 may further comprise one or more metal inserts (also not separately labeled) configured to accommodate a high offset of the carbon brush 40.

The end adapter 50, as best shown in FIG. 5 and with continued reference to FIG. 3, may generally have a trapezoidal shape to confine the trolley lines 38 within a longitudinal plane of the current-collecting rails 36 that may be covered with the carbon brushes 40. In this embodiment, the end adapter 50 includes a horizontal region 57 having a substantially horizontal surface, a second region 58 having a tapered slope inclined upward from the first region 57, a third region 60 having a substantially horizontal surface and a fourth region 62 having a tapered slope inclined downward from the third region 60. Due to spacer 88, a top surface of first region 57 can be flush with an upper surface (not separately labeled) of carbon brush 40.

In an embodiment, the end adapter 50 may additionally comprise a lip protrusion 64 having a horizontal surface extending from an end the fourth region 62 and a second downward tapered slope portion 66. The tapered regions of the end adapter 50 limit the transverse movement of the trolley lines 38, confining the trolley lines 38 and ensuring electrical contact with the current-collecting rails 36 and the carbon brushes 40. Specifically, the tapered slopes of the second regions 58 correct the position of the trolley lines 38 towards the current-collecting rails 36.

As noted above, by maintaining a center of the pantograph assembly 30 under the trolley line 38, the productivity loss, pantograph damage, or catenary damage caused by the heavy-duty work vehicle 10 going off course and disconnecting from the trolley lines 38 can be significantly reduced. To this end, the end adapter 50 includes a mounting assembly 70 FIGS. 6A and 6B configured to support a sensor 72. The sensor 72 may be a distance measurement sensor, such as a time-of-flight sensor, configured to determine a distance to trolley lines 38 along the virtual horizontal plane A including the sliding contacts (FIG. 2). In some embodiments, each end adapter 50 may include the same distance measurement sensor or may include a combination of two or more types of sensors. The mounting assembly may be included on either side of the end adapter, or a mounting assembly may be included on both sides of the end adapter.

The heavy-duty work vehicle 10 may have two pantograph assemblies with at least one pantograph assembly 30 having at least two sensors 72 located on the front and rear current-collecting rails 36. If the heavy-duty work vehicle 10 includes a single pantograph assembly 30, two sensors 72 may be provided. If heavy-duty work vehicle 10 includes two pantograph assemblies 30, four sensors 72 may be provided. As discussed herein, sensors 72 may be time-of-flight (ToF) sensors mounted on each end adapter 50. In addition, the two ToF sensors may be located at opposite sides and offset from each other to avoid sensor interference or cross-talk. In certain embodiments, sensor 72 may take the form of a light detecting and ranging (LiDAR) sensor mounted on the heavy-duty work vehicle 10.

In the illustrated embodiment, the mounting assembly 70 includes a support bracket 74 configured to support the sensor 72. The support bracket 74 may be permanently coupled to the end adapter 50. For example, the support bracket 74 may be fused directly to the end adapter 50. In some constructions, the support bracket 74 may be integrally formed as a single piece with the end adapter 50. In yet another construction, the support bracket 74 may be mechanically coupled and/or releasably coupled to the end adapter 50 via a fastener (e.g., a bolted or other structure), or via another mechanical structure. The end adapter 50 may further include a recessed region (not separately labeled) to facilitate mechanical coupling and/or alignment of the support bracket 74. Overall, it may be desirable to remove or replace the support bracket 74 at multiple points during the life of heavy-duty work vehicle 10 due to damage or replacement/change of the sensor 72 for service/maintenance. Releasably coupling the support bracket 74 facilitates this type of maintenance and interchangeability.

The support bracket 74 may be formed of any number of materials. For example, in some constructions, the support bracket 74 may be formed of steel. In some embodiments, the support bracket 74 is made of a non-conducting material and/or any suitable co-polymer. In other constructions, the support bracket 74 may be formed of the same material as the end adapter 50 or may be formed from a different material. Of course, any other suitable materials may be used without departing from the principles of the present disclosure.

The mounting assembly 70 further includes a cover 76. A top surface 77 of the cover 76 is below the third region 60 of the end adapter 50 to protect the sensor 72 from the trolley lines 38. In this manner, as the trolley lines 38 slide over the end adapter 50, they will not contact and/or damage the sensor. The cover 76 is coupled (e.g., a bolted or other fastening mechanism), to the support bracket 74. One or more shims 78 may be installed on the bottom surface of the support bracket 74 to align the field of view of the sensor 72 with the trolley lines 38 in the virtual horizontal plane A including the sliding contacts. The shims 78 may also provide additional vibrational and shock isolation.

As shown in FIGS. 3, 4, 5, and 6, the mounting assembly 70 is installed on one or more sides of the end adapter 50 and is configured to align the sensor 72 along the virtual horizontal plane A including the sliding contacts. In this arrangement, the sensor 72 may emit light waves along the virtual horizontal plane A including the sliding contacts to detect the presence of the trolley lines 38 and measure a distance between the trolley lines 38 and the virtual horizontal plane A including the sliding contacts. Moreover, the sensor 72 is horizontally offset from the top surface 42 of the current-collecting rails 36 which allows the sensor 72 to detect the trolley line 38 without blockage, for example, of material deposition on the carbon brush (e.g., snow, dust, etc.).

The one or more sensors 72 are communicatively linked to a controller 80 (control module) (FIGS. 1 and 10) and a signal from each sensor is provided to the controller 80. It may be difficult for an operator to see a trolley-pantograph interface with the trolley lines 38 or to see a position of the pantograph assembly 30 by direct observation. To this end, the controller may use the signals from each distance sensor to calculate the distance and proximate location of the trolley line 38 with respect to the pantograph assembly 30. The controller converts the position relationship data into a display to convey to the operator. Controller 80 includes a central processing unit (CPU) 82, a signal processor 84, and a display adapter 86. As will be detailed more fully herein, controller 80 receives signals from sensor(s) 72 indicating a distance to trolley line 38 and/or existence of trolley line 38, processes those signals in signal processor 84, and outputs a display control signal through the display adapter 86 as will be detailed more fully herein.

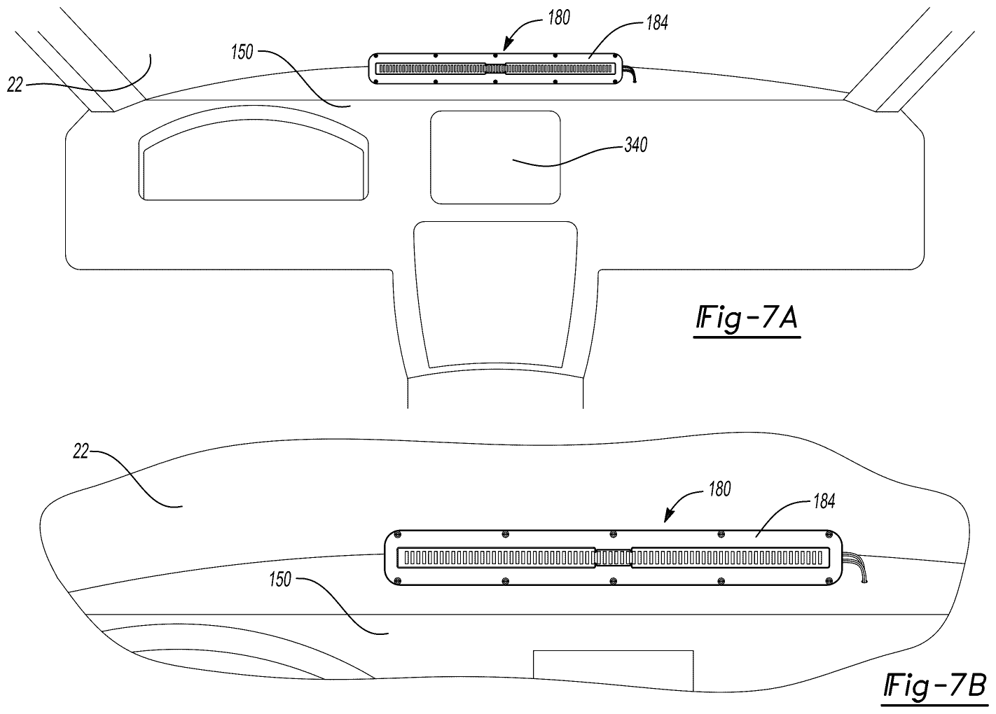

FIGS. 7A and 7B illustrate a visual display 180 including a light bar 184 mounted in the vicinity of the dash panel (operation panel) 150 or in the overhead panel of the operator's cab 22 (see FIG. 1) and, based on signals received from the controller 80 is configured to indicate the proximate location of the trolley lines 38 using individually addressable light sources (e.g., LEDs not separately labeled). The light sources are controlled using, for example, different activation of lights, different colors of light, and different intensities of light. Moreover, the number and color of lights may be controlled, by the controller 80, to convey to the driver the urgency of a required steering action. The illumination of the light sources on the visual display 180 may provide the operator with the average distance of the cables from the center of both pantograph assemblies 30, the degrees of wheel steer required from straight, or an indication of the desired angle of average wheel steer compared to the current position of the average angle of steered wheels on the truck. Further, the driver could be shown whether the trolley guidance system is in a disengaged/pantograph down state, a disengaged/pantograph up state, an engaged but not actively self-guiding state, an engaged and actively self-guiding state, in a temporary error state, or in a fault state.

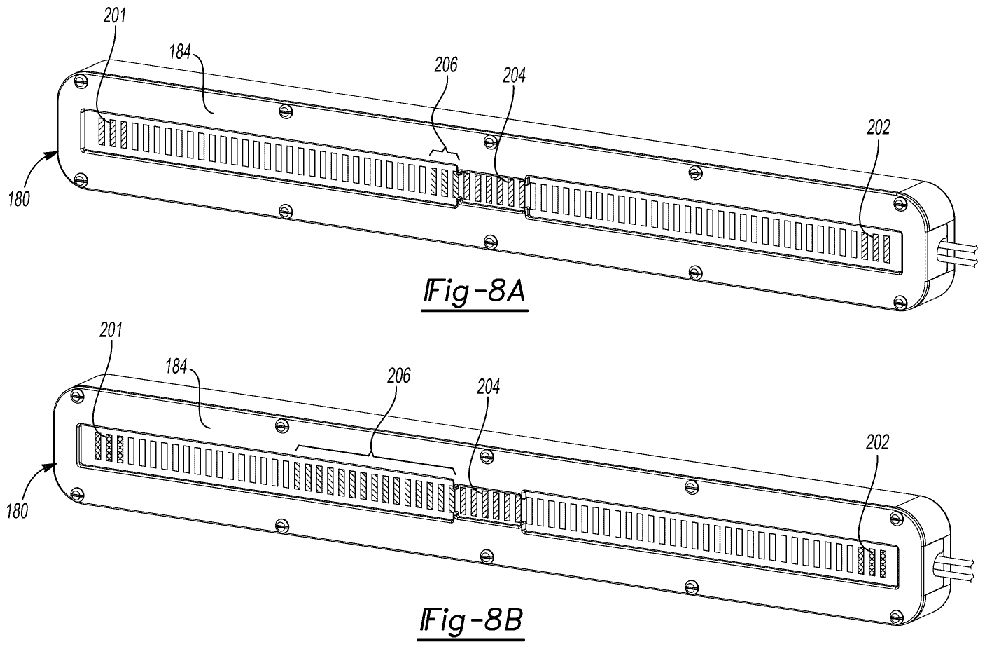

FIGS. 8A and 8B illustrate various implementations and configurations of the light sources of visual display 180 depicted as the light bar 184. The position, color, and/or intensity of the light sources is selectively controlled based on the proximate location of the trolley lines relative to the current-collecting rails 36, in accordance with the present disclosure. As shown in FIG. 8A, the light sources of the visual display 180 are illuminated, in particular colors and at a particular intensity, to indicate that the pantograph assembly 30 is properly aligned with the trolley lines 38 (i.e., the heavy-duty work vehicle 10 is under the center of the trolley lines 38). In this embodiment, the light sources of visual display 180 on both a left end 201 and a right end 202 are illuminated, as a first solid state color (e.g., green), providing visual feedback to an operator to indicate that the trolley line 38 is engaged with the pantograph assembly 30.

As shown in FIG. 8B, the light sources may also be illuminated, as a second solid state color (e.g., red) at left end 201 and right end 202, providing visual feedback to the operator indicating that there is an error or fault state and the center of the heavy-duty work vehicle 10 is deviated from the position of the trolley line 38. Moreover, flashing, strobing, or blinks at either left end 201 and/or right end 202 may be used to provide visual feedback to the operator indicating that there is no power transfer from the trolley line 38. The light sources may be illuminated, as a third solid state color (e.g., yellow) at a position 206 between a center 204 of visual display 180 and left end 201 providing visual feedback to the operator indicating that the heavy-duty work vehicle 10 has deviated from the center of the trolley line 38 to the left and a steering action to steer the heavy-duty work vehicle 10 to the left is required. The light sources at position 206 or at center 204 may be illuminated as the same color or may be illuminated with different colors.

In another example, as shown in FIG. 8A, the light sources are illuminated to indicate that the trolley is engaged and powered, but the vehicle needs a steering command to correct the course toward the left. In this embodiment, light sources at position 206 are illuminated (e.g., in yellow), providing visual feedback to the operator indicating that the distance from the trolley line 38 measured by the ToF sensor. A subset of the light sources at position 206 are illuminated (e.g., in yellow) providing visual feedback to the operator indicating that the trolley line 38 is not completely aligned with a center of pantograph assembly 30. In another example, the distance between the illuminated light sources at position 206 and the center 204 is configured to provide a first visual indication of offset of the trolley line 38.

In another example, a greater number of lights in the subset of the light sources are illuminated to provide visual feedback to the operator indicating that the trolley line 38 is not aligned with the pantograph assembly 30 and/or the center of the heavy-duty work vehicle 10 and an urgent steering command is required. The particular color and/or intensity of illumination for light sources at any positions can continue to be changed simultaneously based on the steering command of the operator. While the examples described above use a light bar, in an alternate embodiment, the same configuration may be applied for different types of displays, such as a heads-up display projected on the windshield of the operator's cab 22 or a virtual light bar display.

In another embodiment, the visual display 180 may be implemented to indicate the “active” or “inactive” states of the trolley lines 38 based on the existence of energization sensed by a conduction sensor (not shown). For example, when the trolley lines 38 are not active, the light sources on the visual display 180 at the left end 201 and right end 202 of the visual display 180 may be blinked in green.

In another embodiment, the one or more distance measurement sensors 72 of FIG. 6 are communicatively linked to the controller 80 (FIG. 10) and a signal from each distance measurement sensor 72 is provided to the controller for an auto-guided steering guidance system 210. The auto-guided steering guidance system 210 allows for a fast and smooth transition between standard steering and an auto-guide mode while preventing productivity loss, pantograph damage, or catenary damage caused by the heavy-duty work vehicle 10 going off course and disconnecting from the trolley lines.

Prior to the operation of the heavy-duty work vehicle 10, mine site and heavy-duty work vehicle 10 information are input into a non-volatile memory 212 of the controller 80. The mine site information may include, but not limited to: (1) a truck model; (2) a position of the pantograph assembly 30; (3) a pantograph width; (4) a pantograph spacing; (5) a number of distance measurement sensors 72; (6) a number of trolley lines 38; (7) a spacing between the trolley lines 38; (8) a thickness of the trolley line 38; (9) a first centerline distance between the trolley lines 38; and (10) a second centerline distance between the pantograph assemblies 30. In addition, the heavy-duty work vehicle 10 information may include, but not limited to: (1) steering gain; (2) forward velocity gain; (3) steering angle; and (4) steering aim point offset limit. Additional information may be input into non-volatile memory 212 without departing from the principles of this disclosure.

In some examples, the controller 80 may receive the information into non-volatile memory 212 over a wireless network or be manually input via an operator. In another embodiment, the information may be programmed and stored in the non-volatile memory 212 of controller 80 prior to the operation. In yet another embodiment, the controller 80 may receive information in non-volatile memory 212 gathered by a drone, a secondary vehicle or various mapping and visualization tools configured to determine the characteristics of the mine site. Additionally, while the information is input into non-volatile memory 212 prior to the operation of the heavy-duty work vehicle 10, the information may be dynamically updated and stored in non-volatile memory 212 to account for variations in the mine site environment or the operating state of the heavy-duty work vehicle 10. For example, the heavy-duty work vehicle 10 information may be automatically or manually updated to account for changes in weather or terrain conditions.

At the beginning, end, or at any point during operation of the heavy-duty work vehicle 10, the controller 80 may receive an output signal from the sensors 72. As described above, the sensors 72 (e.g., time of flight sensors) may be mounted on the end adapters 50 of at least one of the pantograph assemblies 30 to record a position of the trolley line 38 along the longitudinal plane of the current-collecting rails 36. Controller 80 may also receive signals from wheel angle sensors 214, and speed sensors 216 and provide an output to a steering actuation system 218 autonomously control heavy-duty work vehicle 10.

Next, the controller 80 determines a relative position of the trolley line 38 with respect to the pantograph assembly 30 based on a distance between the trolley lines 38 and the end adapters 50 for the fore and aft (front and back) current-collecting rails 36. Using the determined position, the controller 80 calculates the distance between the trolley lines 38 and one of the end adapters 50 for the front and rear current-collecting rails 36 to determine the alignment of the trolley lines 38 with respect to the heavy-duty work vehicle 10. The alignment is calculated based on an offset or difference between the determined distance and the predetermined distance between the center of the current-collecting rails 36 and the end adapter 50.

If the calculated offset is greater than a predetermined limit, the controller 80 may then determine a steering command based on the trolley line angle. The controller 80 may generate a command to control an operational setting of the vehicle to align the current-collecting rails 36 with the trolley lines 38 based on the calculated offset as modified by the input information pertaining to heavy-duty work vehicle 10, the mine site, and other information stored in non-volatile memory 212. The controller 80 may automatically control the heavy-duty work vehicle 10 or send an indication of the misalignment and a user command to an operator to align the heavy-duty work vehicle 10.

In another embodiment, if the calculated offset is greater than a predetermined limit, the controller 80 may determine a command based on the value of the calculated offset. The predetermined limit may comprise a plurality of zones based on the offset distance from the center and the controller may determine a respective command based on each of the zones. For example, if the value of the calculated offset is within a first zone the controller 80 may generate and send an operator an alert or steering command. A second zone, based on a greater offset distance than the first zone, may include the controller 80 overriding the manual controls to autonomously steer the heavy-duty work vehicle 10.

Although the steps of the process are illustrated in a sequential manner, one or more of the steps of the process are capable of being performed before or after one or more other steps of the process.

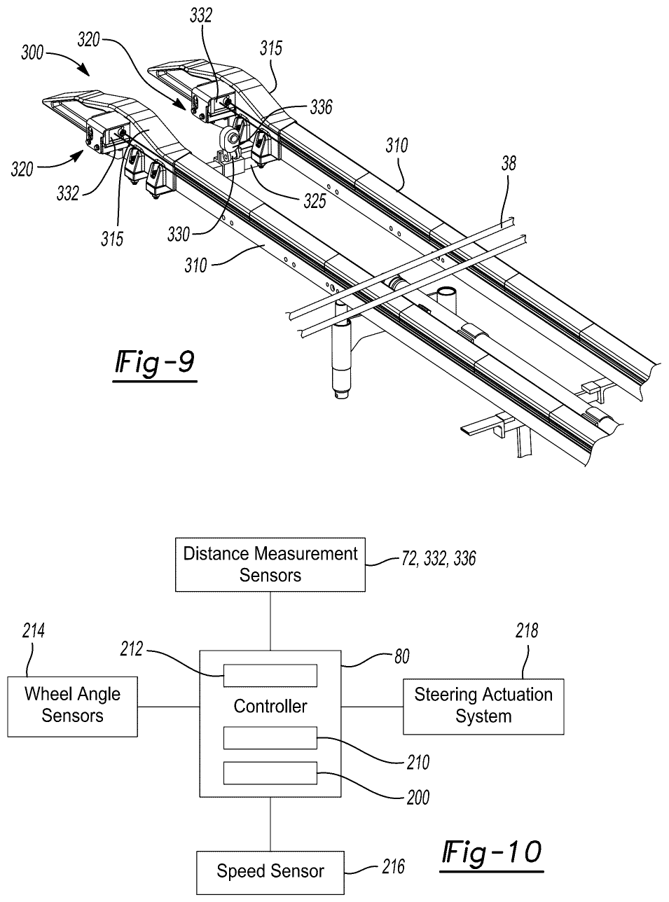

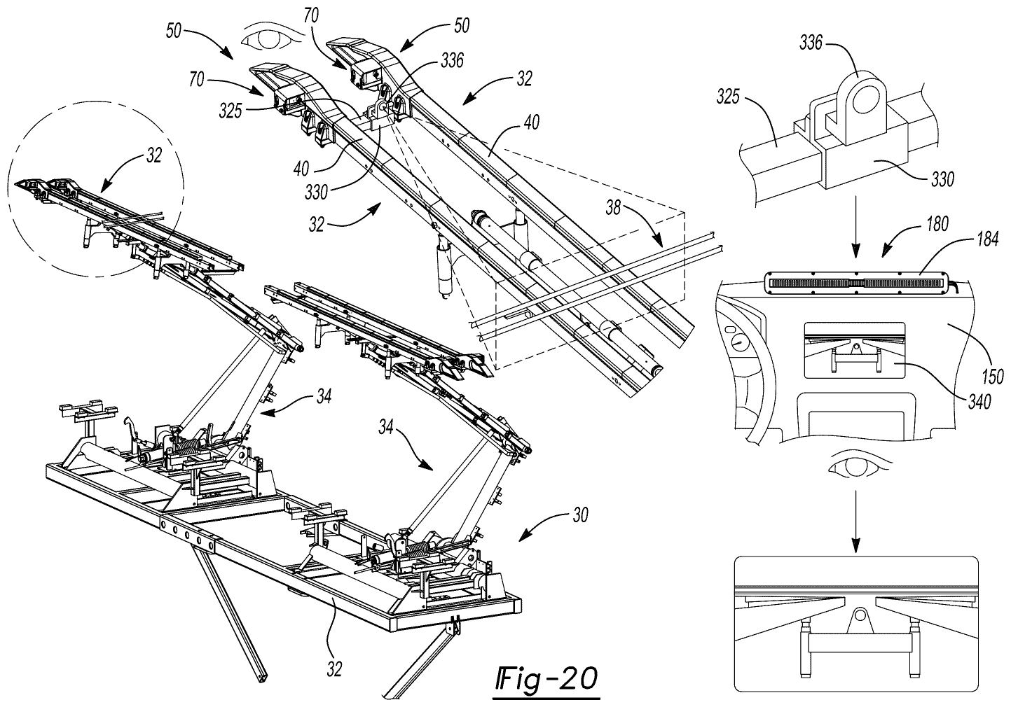

FIG. 9 shows another embodiment of a pantograph assembly 300 for a heavy-duty work vehicle 10 including current-collecting rails 310, end adapters 315 coupled to at least one end of the current-collecting rails 310, and a first mounting assembly 320 configured to support a distance measurement sensor 332 which may include a time of flight (ToF) sensor. The end adapters 315 are coupled to the current-collecting rails 310 through a clamp or bracket (not shown) on a bottom surface of the end adapters 315. A connection rail 325 is arranged perpendicularly relative to the current-collecting rails 310. The connection rail 325 is coupled between two end adapters 315. A second mounting assembly 330 is coupled to the connection rail 325 and is configured to support a camera 336. The camera 336 is supported at a height approximately in line with the trolley lines 38. In this manner, the camera 336 is configured to identify and track the trolley lines 38. The camera 336 is communicatively linked to the controller 80 to allow images to be visually displayed on an operator's display 340 (FIG. 20) or a remote monitor, for example. Advantages of this configuration include maintaining good image quality, ensuring visual inspection of the trolley line 38 and pantograph components and a means for wear monitoring. In addition to the positional detection and the human visual inspection via the operator's display 340, with an AI (artificial intelligence) assisted recognition, the camera 336 and an image recognition system 200 (FIG. 10) are configured to detect wearing of the trolley lines 38 as well as the state of the carbon brush 40 attached to the surfaces of the current-collecting rails 36. Further, in some configurations, the camera 336 with the image recognition system 200 is configured to detect the generation of the arc that can damage the pantograph assembly 30 and the trolley lines 38.

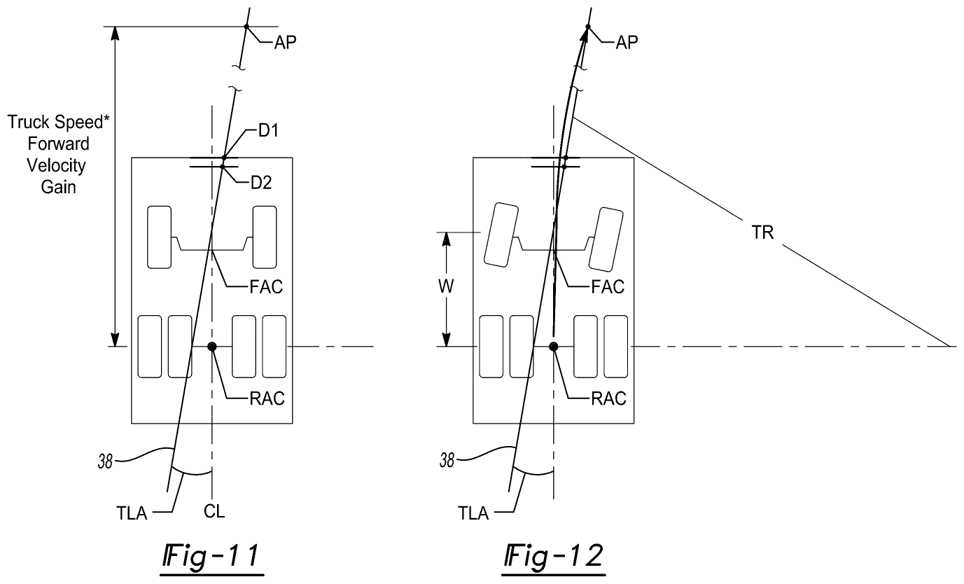

With reference to FIGS. 11 and 12 and with continued reference to FIG. 10, auto-guided steering guidance system 210 will be described in which the controller 80 and steering actuation system 218 can automatically steer the heavy-duty work vehicle 10 along the trolley line 38 (i.e., so that the vehicle can be properly aligned with the trolley line 38 for proper engagement between the trolley line 38 and the current-collecting rails 36. The steering actuation system 218 can be or include a hydraulic steering system (not shown) and/or a steer-by-wire system (also not shown).

As shown in FIG. 10, the controller 80 may be in communication (wired or wireless communication) with the distance measurement sensors 72, 332, the camera 326, one or more wheel angle sensors 214 (which communicate to the controller 80 a current angle at which the steerable wheels of the heavy-duty work vehicle 10 are positioned), speed sensor 216 (which communicate to the controller a current velocity of the heavy-duty work vehicle 10), and the steering actuation system 218. As described above, the distance measurement sensor 72, 332 determine a distance from the trolley line 38. As shown in FIG. 11, a first distance D1 is a distance measured by a distance measurement sensor 72, 332 disposed on a front one of the current-collecting rails 36, 310 and a second distance D2 is a distance measured by a distance measurement sensor 72, 332 disposed on a rear one of the current-collecting rails 36, 310. The controller 80 can calculate a trolley line angle TLA of the trolley line 38 relative to a fore-to-aft centerline CL of the heavy-duty work vehicle 10 that passes through a front axle center point (FAC) and rear axle center point (RAC) of the heavy-duty work vehicle 10 (see FIG. 11). The controller 80 may then determine an aim point (AP) (FIGS. 11 and 12) which will be disposed along the trolley line 38 at a distance that is scaled with speed of the vehicle. For example, the controller 80 may set the aim point (AP) at a distance that is equal to the speed of the vehicle (as determined by the speed sensor 216) multiplied by a forward velocity gain value. The forward velocity gain value may be a predetermined constant value that is pre-programmed into the non-volatile memory 212.

The controller 80 may then determine a steering angle at which the heavy-duty work vehicle 10 can be steered to the aim point (AP) to reduce the distances captured by distance measurement sensors 72, 323 and bring the fore-aft centerline of the heavy-duty work vehicle 10 into alignment (or close to alignment) with the trolley line 38 (i.e., to keep the trolley line 38 at or closer to the center of the current-collecting rails 36). To determine the steering angle, the controller 80 may calculate a radius of an arc that is defined by the aim point (AP), the rear axle center point RAC (e.g., a point at the intersection of the fore-aft center line and the rear axle center line, as shown in FIG. 12), and a mirrored aim point (e.g., the aim point mirrored about the rear axle center line). The radius of this arc may be the turning radius at which the heavy-duty work vehicle 10 may be steered to the aim point. The controller 80 may calculate the steering angle α (alpha) according to the following equation:

$$R = \frac{W}{tan α}$$

where W is the wheelbase (i.e., distance between the rear axle RAC and the front axle centerline FAC), R is the turning radius TR (i.e., the radius of the arc defined by the aim point AP, the rear axle center point RAC, and the mirrored aim point).

The controller 80 may then cause the steering actuation system 218 to move the front wheels 26 of the heavy-duty work vehicle 10 (or the back wheels 28 of the heavy-duty work vehicle 10 if the vehicle's rear wheels are steerable) to the steering angle α (alpha). For example, the controller 80 may compare the steering angle to a current angle of the steerable wheels of the vehicle (based on information from the wheel angle sensor(s)) and cause the steering actuation system 218 to move the steerable wheels from the current angle to the desired steering angle. The controller 80 may continuously or intermittently recalculate the aim point AP, turning radius TR and steering angle in the manner described above until the trolley line 38 is centered on the current-collecting rails 36 (or until the trolley line 38 is positioned as desired relative to the current-collecting rails 36).

In some configurations, the controller 80 may adjust the steering angle by multiplying the steering angle by a steering gain value. The steering gain value may be a predetermined value that is pre-programmed into the controller.

It should be appreciated that the term “controller” as used herein could include a single physical controller or multiple separate physical controllers that may bed co-located or arranged in different portions of heavy-duty work vehicle 10, that communicate with each other, and each perform certain steps or functions of the method described above.

In some configurations of the heavy-duty work vehicle 10, once the vehicle's trolley mode is engaged (i.e., once the current-collecting rails 36 contact the trolley line 38 and electrical power is transmitted to the heavy-duty work vehicle 10 from the trolley line 38), the steering actuation system 218 may be initiated to actively steer the heavy-duty work vehicle 10 according to the method described above. The auto-guided steering guidance system 210 can be overridden (or cancelled) by an operator (e.g., a person in the operator's cab 22 of the heavy-duty work vehicle 10 or a person remotely controlling the heavy-duty work vehicle 10). For example, this overriding of auto-guided steering guidance system 210 could be accomplished by the operator manually turning a steering wheel or joystick. Such manual steering input from the operator will cancel or deactivate the auto-guided steering guidance system 210. In some configurations, the operator may re-initiate the auto-guided steering guidance system 210 if desired via a control interface in the cab.

In some configurations, the auto-guided steering guidance system 210 may be cancelled if faults or errors are detected with respect to any of the sensors used by the controller 80 for the auto-guided steering guidance system 210. Under such circumstances, the controller 80 may actuate audible, visual, and/or tactile notifications (i.e., lights, sounds, vibrations, and/or other notifications) to notify the operator to take manual control of the vehicle's steering.

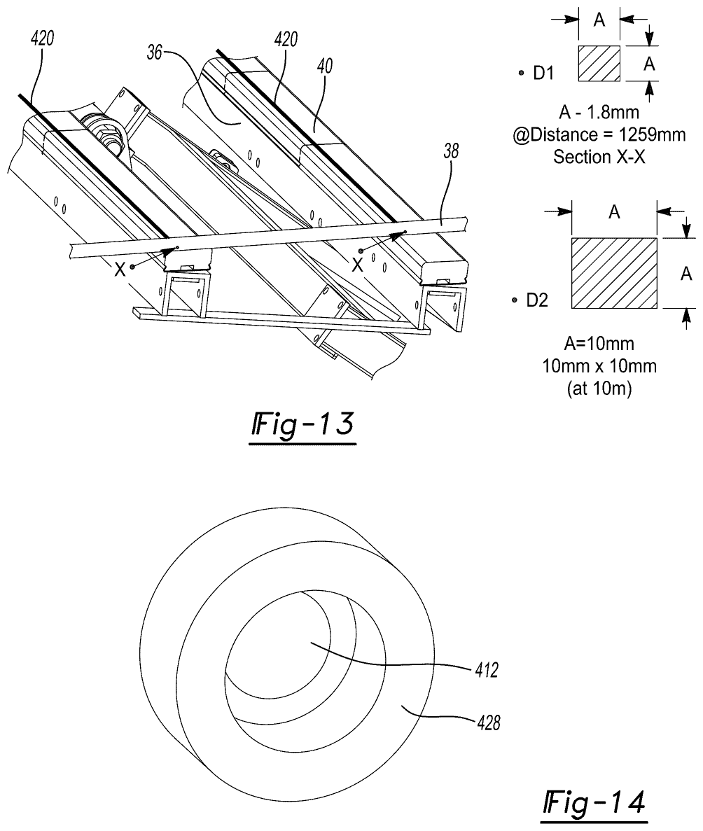

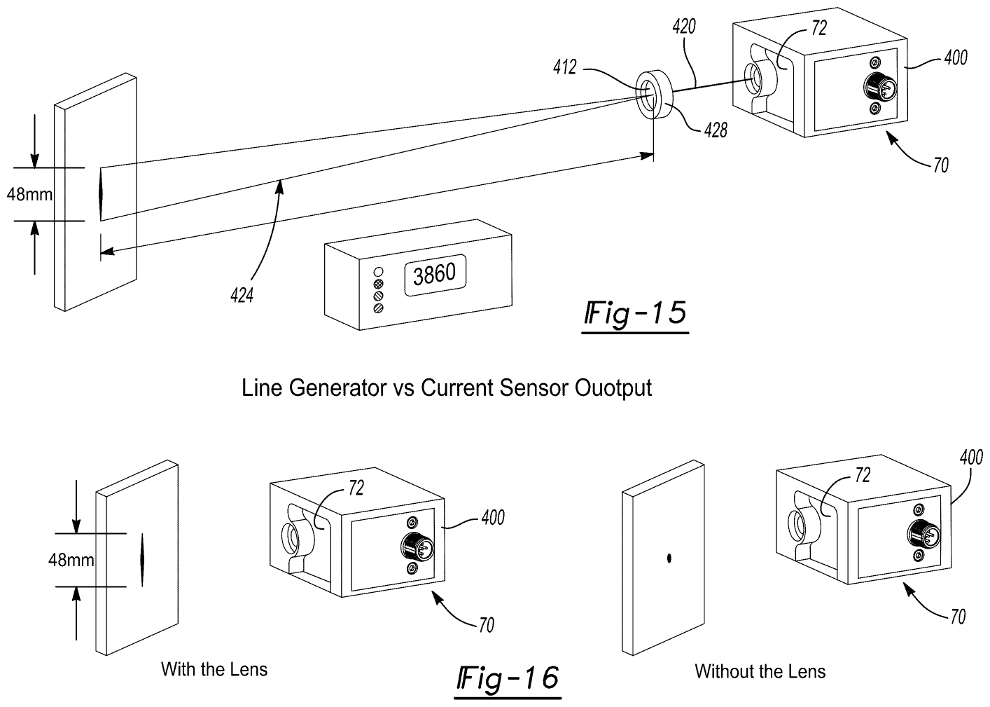

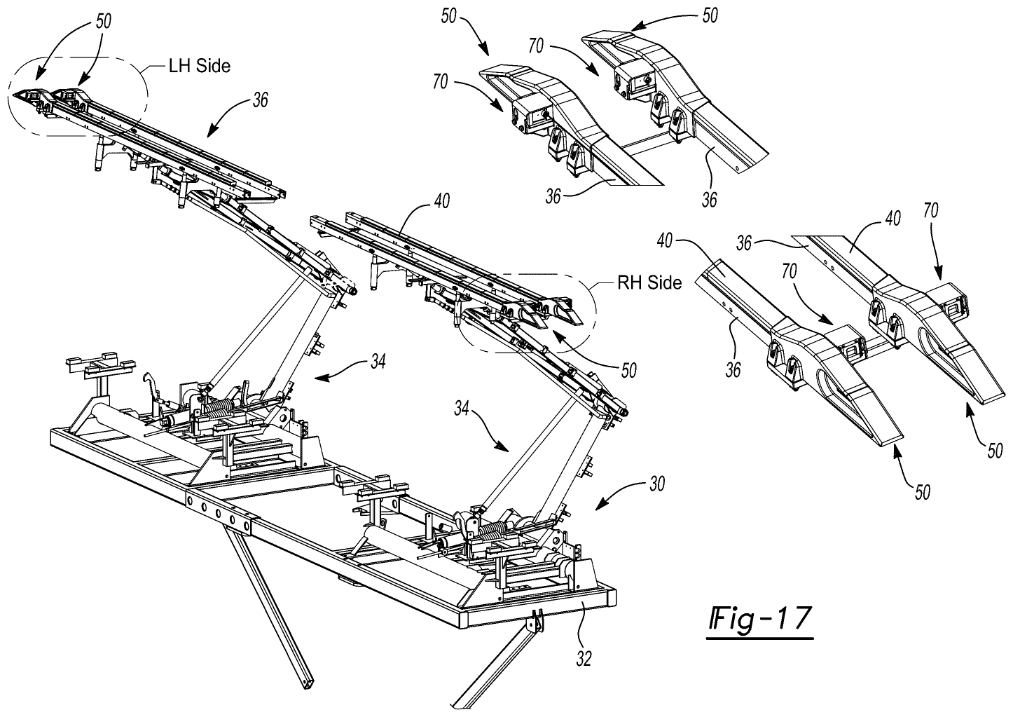

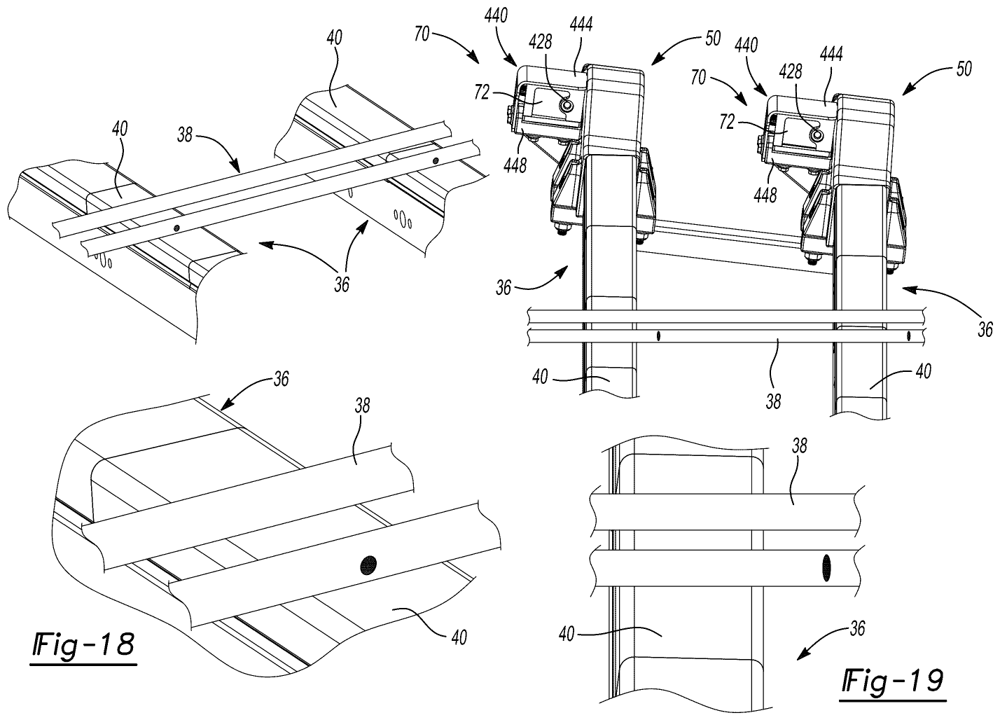

FIGS. 13, 14, 15, 16, 17, 18, 19, and 20 depict concepts related to example embodiments of the distance measurement sensors 72 and the mounting of the sensors 72 on the pantograph assembly 30. In some configurations, the distance measurement sensors 72, 323 may each include a laser source 400 and a lens 412 (e.g., a cylindrical lens) such as shown in FIG. 15. The laser source 400 may produce a collimated laser beam 420 that passes through the cylindrical lens 412. The cylindrical lens 412 may be a round bar or cross section of glass through which the collimated laser beam 420 passes and is spread into a fan beam 424. This may allow for simplified installation of the sensor 72 without the need for precision alignment, since the collimated laser beam 420 can be stretched in a vertical plane as depicted in FIGS. 15 and 16 to hit the overhead wire or trolley lines more readily 38.

The lens 412 may be mounted in a cylindrical housing 428 (see FIG. 14). The lens 412 and cylindrical housing 428 may be mounted within a sensor bracket assembly 440 as shown in FIG. 19, the sensor bracket assembly 440 may include a sensor top holder 444 and a base holder 448. The sensor bracket assembly 440 may be mounted to the end adapter 50 of the pantograph assembly 30. The collimated laser beam 420 is directed at trolley line 38. A return signal from trolley line 38 is detected by sensor 72. Controller 80 (FIG. 10) processes the return signal to determine a position of trolley line 38 on pantograph assembly 30. Controller 80 may then implement auto-guided steering guidance system 210 to control a position of heavy-duty work vehicle 10 relative to trolley line 38 to ensure continued contact and electrical energy delivery.

In this application, including the definitions below, the term “control module” or the term “controller” may be replaced with the term “circuit.” The term “module,” “control module,” “control circuitry,” or “control system” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of automatically steering a vehicle, the method comprising:
determining a first distance from a first point to a trolley line;
determining a second distance from a second point to the trolley line;
determining an aim point based on the first and second distances and a vehicle velocity;
determining a turning radius of an arc defined by the aim point, a rear axle center point, and a mirrored aim point;
determining a steering angle based on the turning radius and wheelbase length of the vehicle;
comparing the steering angle to a current angle of steerable wheels of the vehicle; and
determining an amount and direction in which the steerable wheels are to be moved to direct the vehicle toward the aim point.

2. The method of claim 1, further comprising: automatically steering the vehicle toward the aim point.

3. The method of claim 2, wherein automatically steering the vehicle toward the aim point includes maintaining contact between current-collecting rails on the vehicle and the trolley line.

4. The method of claim 3, further comprising: continuously updating the aim point to maintain the trolley line centered on the current-collecting rails.

5. The method of claim 1, wherein determining the first distance includes calculating a trolley line angle of the trolley line relative to a fore-to-aft centerline of the vehicle.

6. The method of claim 1, wherein determining the aim point includes setting the aim point at a distance that is equal to vehicle speed multiplied by a forward velocity gain value.

7. A pantograph assembly for a vehicle comprising:
a linkage configured to be mounted to the vehicle and movable relative to the vehicle between a stowed position and a deployed position;
a current-collecting rail supported by the linkage, wherein the current-collecting rail is configured to slidingly contact an overhead wire when the linkage is in the deployed position, and wherein the current-collecting rail is spaced apart from the overhead wire when the linkage is in the stowed position; and
a sensor assembly mounted to the current-collecting rail and configured to detect a distance from the overhead wire, wherein the sensor assembly includes a sensor and a support bracket, and wherein the support bracket is mounted to the current-collecting rail and supports the sensor.

8. The pantograph assembly of claim 7, further comprising an end adapter attached to an end of the current-collecting rail, wherein an uppermost surface of the sensor is disposed vertically below an uppermost surface of the end adapter.

9. The pantograph assembly of claim 7, wherein the sensor assembly includes a time-of-flight sensor.

10. The pantograph assembly of claim 7, wherein the sensor assembly includes a LIDAR sensor.

11. The pantograph assembly of claim 7, wherein the sensor assembly includes a cylindrical lens into which a collimated beam is transmitted, and wherein the cylindrical lens spreads the collimated beam into a fan beam.

12. The pantograph assembly of claim 7, wherein the sensor assembly is in communication with a guidance system.

13. The pantograph assembly of claim 12, wherein the guidance system includes a plurality of lights disposed in a cab of the vehicle, and wherein the lights are operable to indicate a position of the vehicle relative to the overhead wire.

14. The pantograph assembly of claim 13, wherein the guidance system includes a control module in communication with the sensor assembly and the lights, and wherein the control module controls operation of each of the lights based on data received from the sensor assembly.

15. A work vehicle comprising:
a frame including a cab;
a plurality of wheels that are rotatable relative to the frame;
an electrical system associated with an electric motor configured to drive one or more of the wheels;
a pantograph assembly mounted to the frame and movable relative to the frame between a stowed position and a deployed position, wherein the pantograph assembly includes a current-collecting rail that is configured to slidingly contact an overhead wire and transmit electrical current from the overhead wire to the electrical system when the pantograph assembly is in the deployed position, and wherein the current-collecting rail is electrically disconnected from the overhead wire when the pantograph assembly is in the stowed position;
a sensor assembly mounted to the pantograph assembly and configured to detect a distance from the overhead wire;
a visual display disposed within the cab and configured to provide visual indicia of a position of the work vehicle relative to the overhead wire; and
a control module in communication with the sensor assembly and the visual display and configured to control the visual indicia on the visual display based on data received from the sensor assembly, wherein the sensor assembly includes a sensor and a support bracket, and wherein the support bracket supports the sensor and is mounted to an end adapter attached to the current-collecting rail.

16. The work vehicle of claim 15, wherein an uppermost surface of the sensor is disposed vertically below an uppermost surface of the end adapter.

17. The work vehicle of claim 15, wherein the sensor assembly includes a time-of-flight sensor.

18. The work vehicle of claim 15, wherein the sensor assembly includes a LIDAR sensor.

19. The work vehicle of claim 15, wherein the sensor assembly includes a cylindrical lens into which a collimated beam is transmitted, and wherein the cylindrical lens spreads the collimated beam into a fan beam.

20. The work vehicle of claim 15, wherein the current-collecting rail includes a first current-collecting rail and a second current-collecting rail joined by a connection rail arranged perpendicularly to the first current-collecting rail and the second current-collecting rail, the sensor comprising a camera mounted to the connection rail.
